(19) United States
(12) Patent Application Publication
(10) Pub. No.: US 2008/0246745 A1
(43) Pub. Date: Oct. 9, 2008

(54) STYLUS FOR PORTABLE ELECTRONIC DEVICE

(75) Inventors: ZHENG SHI, Shenzhen (CN); CHIH-CHIANG CHANG, Taipei Hsien (TW); YAO-HAO CHANG, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/871,930

(22) Filed: Oct. 12, 2007

(30) Foreign Application Priority Data
Apr. 6, 2007 (CN) 200710073961.5

(51) Int. Cl. G06F 3/033; G06F 3/041; G09G 5/00

(52) U.S. Cl. 345/179; 178/18.01; 345/173

(57) ABSTRACT

A portable electronic device (40) includes a housing (41), a display section (42) formed on the housing, and a stylus (20) connected to the housing. The display section has a screen. The stylus includes a writing portion (21), a sleeve (23), and a holder (25) formed on the sleeve. The writing portion is for moving on the screen of the display section. The sleeve has a first end (231) connecting with the writing portion, and an opposite second end being open.

### BACKGROUND OF THE INVENTION

1. Field of the Invention

The present invention generally relates to styluses and, particularly, to a stylus used as an input device on a pressure-sensitive screen of a portable electronic device.

2. Discussion of the Related Art

With the recent development of the technology of information processing, portable electronic devices such as mobile phones and personal digital assistants (PDAs) are now in widespread use. Such a portable electronic device looks similar to a hand-held computer and able to perform tasks of recording a diary, a personal database or an alarm clock etc. The portable electronic device generally has a large screen and the screen is typically a pressure-sensitive screen. A stylus is needed as an input device for writing, marking, or engraving on the pressure-sensitive screen.

In some electronic devices, the stylus is mounted to/into a housing of a given electronic device. The housing of the electronic device has a deep hole defined, e.g., in one sidewall thereof. An extending direction of the hole is substantially parallel to the sidewall. The stylus is substantially a thin and long pole in shape. The stylus is configured (i.e., structured and arranged) for being received in the hole of the housing by friction therebetween and may be pulled out manually from the hole. However, the stylus is too thin to be held, which makes it inconvenient for the users.

Therefore, a new stylus for portable electronic device is desired in order to overcome the above-described shortcoming.

### SUMMARY

In one aspect thereof, a stylus for a portable electronic device includes a writing portion, a sleeve connected to the writing portion, and a holder formed on the sleeve. The sleeve has a first end connected to the writing portion, and an opposite second end being open. The holder is formed on a peripheral wall of the sleeve.

In another aspect thereof, a portable electronic device includes a housing, a display section formed on the housing, and a stylus connected to the housing. The display section contains a screen. The stylus includes a writing portion, a sleeve, and a holder. The writing portion is configured for moving on the screen of the display section. The sleeve has a first end connected to the writing portion, and an opposite second end being open. The holder is formed on a peripheral wall of the sleeve.

Other advantages and novel features of the embodiments will become more apparent from the following detailed description thereof when taken in conjunction with the accompanying drawings.

### BRIEF DESCRIPTION OF THE DRAWINGS

Many aspects of the present stylus can be better understood with reference to the following drawings. The components in the drawings are not necessarily to scale, the emphasis instead being placed upon clearly illustrating the principles of the present stylus. Moreover, in the drawings, like reference numerals designate corresponding parts throughout the several views.

FIG. 1 is a schematic view of a portable electronic device in accordance with a present embodiment;

FIG. 2 is an enlarged, isometric view of the stylus shown in FIG. 1;

FIG. 3 is a partly cut-away view along line III-III of FIG. 2; and

FIG. 4 is a schematic view of the portable electronic device shown in FIG. 1, in an operational state.

### DETAILED DESCRIPTION OF THE EMBODIMENT

The present stylus is particularly suitable for portable electronic devices such as mobile phones, PDAs, and the like. Other applications could also be found in which a similar stylus is employed.

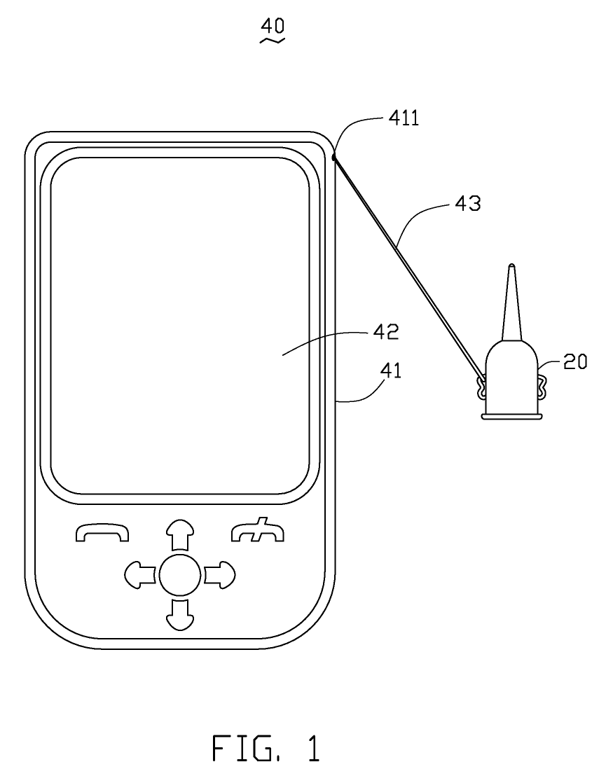

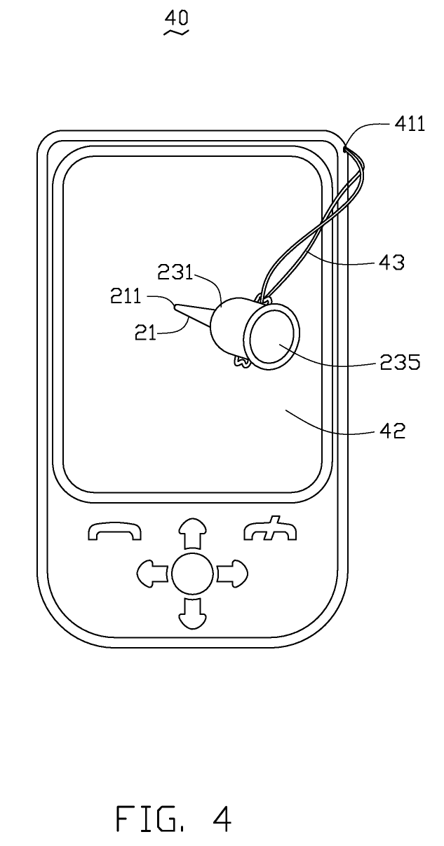

Referring to the drawings in detail, FIGS. 1 and 4 show a portable electronic device 40 having a stylus 20. The stylus 20 is connected to the portable electronic device 40 by a line 43.

The portable electronic device 40 includes a housing 41 and a display section 42 mounted on the housing 41. The housing 41 has a positioning element 411 configured (i.e., structured and arranged) for fixing one end of the line 43 to the housing 41. The display section 42 has a relatively large and pressure-sensitive screen.

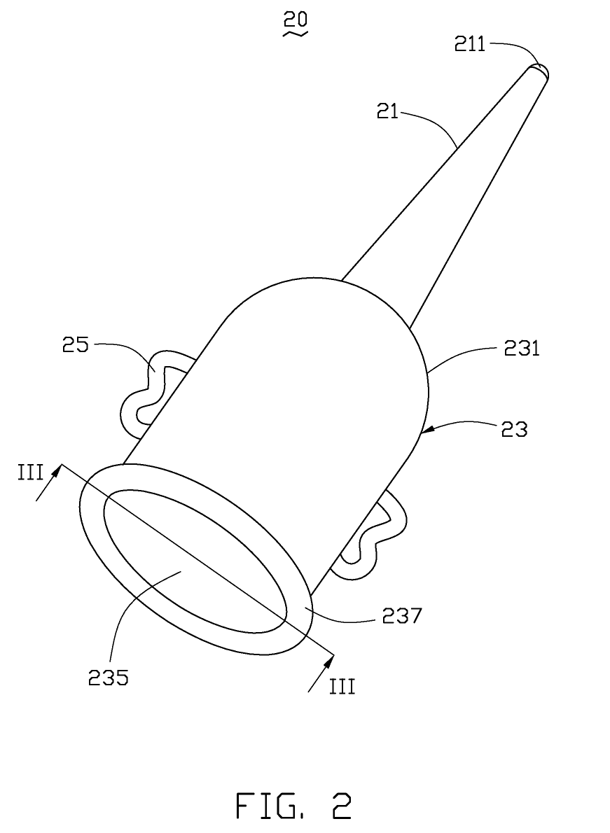

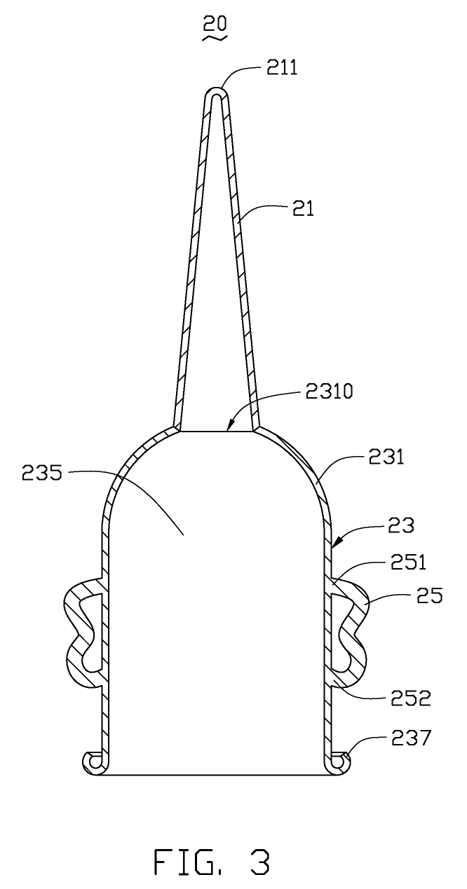

Also referring to FIGS. 2 and 3, the stylus 20 includes a writing portion 21, a sleeve 23 connected to the writing portion 21, and two holders 25 extending from substantially opposite positions of the sleeve 23. The writing portion 21 is substantially hollow cone-shaped. The writing portion 21 has one end connected to the sleeve 23 and a distal end 21 1configured for writing, marking, or engraving on the pressure-sensitive screen of the display section 42. The writing portion 21 is preferably made of thermo plastic urethane (TPU).

The sleeve 23 is substantially a hollow cylinder in shape, and has a cavity 235 defined therein. The sleeve 23 has a half-closed end 231 and an opposite open end (not labeled). The first end 231 is substantially a hollow half-sphere in shape, and has a cutout 2310 defined therethrough. Particularly referring to FIG. 3, the writing portion 21, from internal view, is structured and arranged to communicate with the sleeve 23. The cavity 235 is configured for receiving a portion of a finger of a user. A brim 237 is formed on the second end of the sleeve 23. The sleeve 23 is preferably made of acrylonitrile butadiene styrene (ABS) or polycarbonate (PC).

Each holder 25 is e-shaped and has two distal ends 251, 252. The two distal ends 251, 252 are formed on the peripheral wall of the sleeve 23. The line 43 may have one end thereof connected to one or two of the holders 25 thereby firmly connecting the stylus 20 to the housing 41.

Further referring to FIG. 4, in use, the user may partly insert his/her finger into the cavity 235 of the sleeve 23, and thereby the user can use the stylus 20 to write, mark, or engrave on the pressure-sensitive screen of the display section 42. Alternatively, the user can hold the sleeve 23 to use the stylus 20. The stylus 20 has a relatively large volume, which makes it more convenient to use. When the stylus 20 is not in use, it is not susceptible to lose because the line 43 firmly connects the stylus 20 to the housing 41.

It is to be understood that the writing portion 21, the sleeve 23, and the holders 25 may alternatively have other shapes. The number of the holders 25 may be one or more than two.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stylus for a portable electronic device, the stylus comprising:
a writing portion;
a sleeve connected to the writing portion at a first end thereof, and the sleeve having an opposite second end being open; and
a holder formed on the sleeve.

2. The stylus as claimed in claim 1, wherein the sleeve has a cavity defined therein, and the cavity communicates with the outside through the second end.

3. The stylus as claimed in claim 2, wherein the holder is formed on a peripheral wall of the sleeve.

4. The stylus as claimed in claim 1, wherein a brim is formed on the open end of the sleeve.

5. The stylus as claimed in claim 1, wherein the writing portion is substantially hollow cone-shaped.

6. The stylus as claimed in claim 1, wherein the writing portion is preferably made of thermo plastic urethane (TPU).

7. The stylus as claimed in claim 1, wherein the sleeve is substantially a hollow cylinder in shape.

8. The stylus as claimed in claim 1, wherein the first end of the sleeve is substantially a hollow half-sphere in shape.

9. The stylus as claimed in claim 1, wherein the sleeve is preferably made of one of acrylonitrile butadiene styrene (ABS) and polycarbonate (PC).

10. The stylus as claimed in claim 1, wherein the holder is e-shaped.

11. A portable electronic device comprising:
a housing;
a display section having a screen and the display section being formed on the housing; and
a stylus mounted to the housing, the stylus comprising:
a writing portion configured for moving on the screen of the display section;
a sleeve having a first end connected to the writing portion, and an opposite second end being open; and
a holder formed on the sleeve.

12. The portable electronic device as claimed in claim 11, wherein the sleeve has a cavity defined therein, and the cavity communicates with the outside through the second end.

13. The portable electronic device as claimed in claim 12, wherein the holder is formed on a peripheral wall of the sleeve.

14. The portable electronic device as claimed in claim 11, wherein a brim is formed on the second end of the sleeve.

15. The portable electronic device as claimed in claim 11, wherein the screen of the display section is a pressure-sensitive screen.

16. The portable electronic device as claimed in claim 11, wherein the stylus is connected to the housing by a line, one end of the line being fixed to the housing, and the other end of the line being connected to the holder of the stylus.

17. The portable electronic device as claimed in claim 11, wherein the sleeve is substantially a hollow cylinder in shape.

18. The portable electronic device as claimed in claim 11, wherein the holder is e-shaped.
